(19) United States
(12) Patent Application Publication
(10) Pub. No.: US 2016/0288360 A1
(43) Pub. Date: Oct. 6, 2016

(54) WOODEN TENON PRESS AND CONNECTION MACHINE

(71) Applicant: CHENG KUANG WOOD MACHINERY WORKS CO., LTD., Taichung (TW)

(72) Inventors: CHIN-LIANG TU, Taichung (TW); I-LUN TU, Taichung (TW); SHIH-CHANG TSAI, Taichung (TW)

(21) Appl. No.: 14/672,676

(22) Filed: Mar. 30, 2015

(51) Int. Cl. B27G 11/00; B27M 1/08; B27F 1/08

(52) U.S. Cl. CPC B27G 11/00; B27F 1/08; B27M 1/08

(57) ABSTRACT

A wooden tenon press and connection machine for coupling a plurality of wooden strips includes a station and a slide deck located on the station, a plane cutting device, a sawtooth cutting device, a gluing device, a thrust device and a press device that are located on the station. The slide deck carries the wooden strips sliding so that end surfaces at two sides of the wooden strips can pass through respectively a plane cutter of the plane cutting device and a sawtooth cutter of the sawtooth cutting device to form a wooden tenon on each of the end surfaces at two sides of the wooden strips. The two wooden tenons are daubed with a glue through the gluing device, and pressed through the press device and pushed and moved through the thrust device so that corresponding tenons of the wooden strips are tightly coupled together.

### FIELD OF THE INVENTION

The present invention relates to a wooden tenon press and connection machine and particularly to a wooden tenon press and connection machine to couple wooden strips.

### BACKGROUND OF THE INVENTION

Wood is a regenerating natural resource, thus is a well-accepted environment-friendly material, and is widely used to make various types of products, such as furniture, artifacts, hand tools and the like. Wood also can be directly used as building material to form beams, posts and light partitions and the like.

Tree is a natural growing material with the appearance looked like a cylindrical post. But each tree has a different shape and dimension, therefore has to be cut and sliced to form usable wood. In general, the price of same kind of wood increases exponentially with increasing dimensions. Namely, the wood of a larger dimension is priced much greater than that of a smaller dimension.

Therefore in order to increase the utilization value of wood the peripheral and remanent woods left after a tree is cut and sliced are generally being spliced to form usable woods. In addition, in order to meet use requirements woods of normal dimensions also can be spliced to form woods of a greater dimension.

Please refer to FIG. 1 for a conventional pressing machine 1 for splicing wooden strips 2a, 2b and 2c. The wooden strips 2a, 2b and 2c are remanent woods after cutting and slicing that are formed in shorter dimensions. They have to be spliced in a serial fashion to increase the length. To achieve such a purpose each end surface of two ends of the wooden strips 2a, 2b and 2c has to be fabricated to form a wooden tenon 3, then the wooden tenons 3 are glued and spliced together through the pressing machine 1. First, one end of the first wooden strip 2a is leaned on a leaning panel 4 of the pressing machine 1; next, make a wooden tenon 3 of the second wooden strip 2b in contact with another wooden tenon 3 of the first wooden strip 2a, and splice the third wooden strip 2c in this order; then push the wooden tenons 3 of the wooden strips 2a, 2b and 2c to couple together in pair through a thrust force from a thrust portion 5, thereby splice the wooden strips 2a, 2b and 2c together.

During the third wooden strip 2c is thrust by the thrust portion 5, to avoid the junctions of the wooden tenons 3 of the wooden strips 2a, 2b and 2c at the front side from warping upon receiving the pressure, an upper press plate 6 is employed during the thrust process to press and keep the junctions of the wooden tenons 3 of the spliced wooden strips 2a, 2b and 2c in a smooth and neat condition.

The allowable length of the wooden strips 2a, 3b and 2c that can be spliced on the conventional pressing machine 1 is limited by the length of the pressing machine 1, and cannot be increased flexibly. The upper press plate 6 must be formed at a length same as the pressing machine 1 to prevent the junctions of the wooden tenons 3 of the wooden strips 2a, 2b and 2c from warping upon receiving the pressure. In order to make the upper press plate 6 movable up and down, a plurality of pylons 7 and upward movable elements 8 also must be provided. All this takes significant space and also is costly, hence cannot fully meet use requirements.

### SUMMARY OF THE INVENTION

The primary object of the present invention is to disclose a wooden tenon press and connection machine that can flexibly increase spliced length of wooden strips and reduce equipment cost and space to meet fabrication requirements.

The wooden tenon press and connection machine according to the invention aims to couple a plurality of wooden strips, and includes a station, a plane cutting device, a sawtooth cutting device, a slide deck, a gluing device, a press device and a thrust device. The station has a working plane. The plane cutting device is mounted onto the working plane and has a plane cutter. The sawtooth cutting device is mounted onto the working plane and has a sawtooth cutter.

The slide deck is located on the station and has a holding deck to hold a plurality of the wooden strips, a leaning panel located at one side of the holding deck, a clamp panel movable close to the leaning panel to clamp the wooden strips, and a slide element to carry and slide the holding deck. Through sliding of the slide element two side end surfaces of the wooden strips can pass through the plane cuter and the sawtooth cutter to form a wooden tenon on each of the end surfaces of the wooden strips.

The gluing device is mounted onto the working plane and has a glue box to receive the wooden tenon of the wooden strips. The glue box contains a glue to daub on the wooden tenon.

The press device is mounted onto the working plane and has a press plate movable up and down to press the wooden strips at a selected pressure. The thrust device is mounted onto the working plane and has a thrust portion which has a movement path toward the press plate. Any one of the wooden strips can be held by the press plate in a fixed manner with the wooden tenon facing the thrust portion which thrusts another one of the wooden strips so that the two wood tenons are moved close to each other and coupled together.

Thus, by pressing the wooden strips, the length of the spliced wooden strips can be increased flexibly without being constrained the distance between the thrust portion and the press plate. In the event that the push force of the thrust portion is too much at the moment of coupling of the two wooden tenons, the wooden strips can slide on the working plane to absorb excessive impact force to avoid the wooden strips from fracturing, and also prevent warping at the junctions of the wooden tenons due to excessive forces received by the wooden strips. Hence the upper press plate can be dispensed with to save fabrication cost. The invention integrates all the equipment required for laminating the wooden tenons on the same station, hence also can save plant space to meet fabrication requirements.

The foregoing, as well as additional objects, features and advantages of the invention will be more readily apparent from the following detailed embodiments and description, which proceed with reference to the accompanying drawings. The embodiments merely serve for illustrative purpose and are not the limitation of the invention.

### BRIEF DESCRIPTION OF THE DRAWINGS

FIG. 1 is a schematic view of a conventional pressing machine for coupling wooden strips.

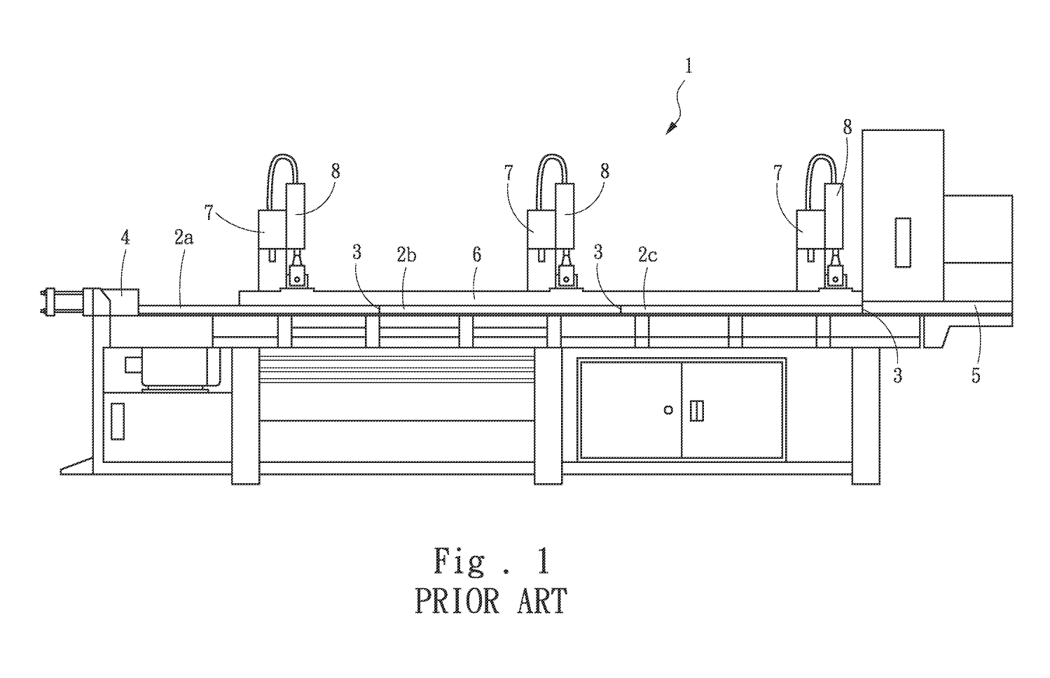

FIG. 2 is a perspective view of the invention.

FIG. 3A is a front view of the invention.

FIG. 3B is a front view of the invention after the rotary bar is rotated.

FIG. 4 is a schematic view of another embodiment of the invention in a use condition.

FIG. 5A is a schematic view of the invention in a use condition for coupling wooden strips.

FIG. 5B is a schematic view of the invention in another use condition for coupling wooden strips.

### DETAILED DESCRIPTION OF THE PREFERRED EMBODIMENTS

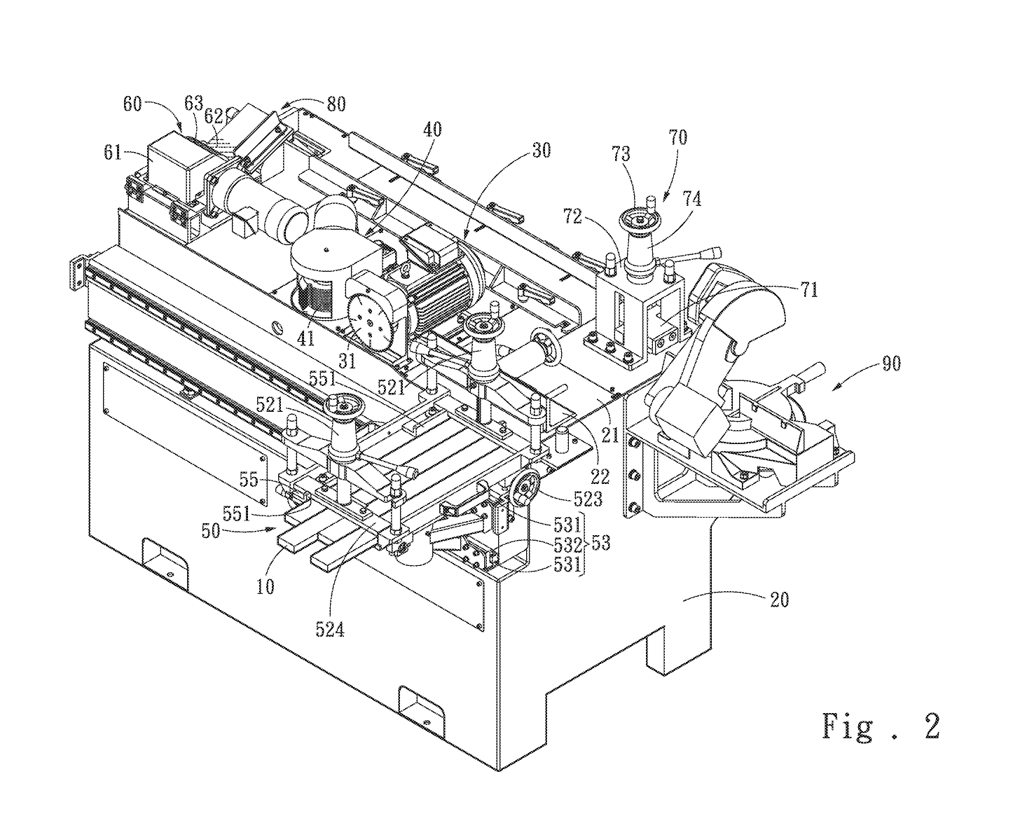

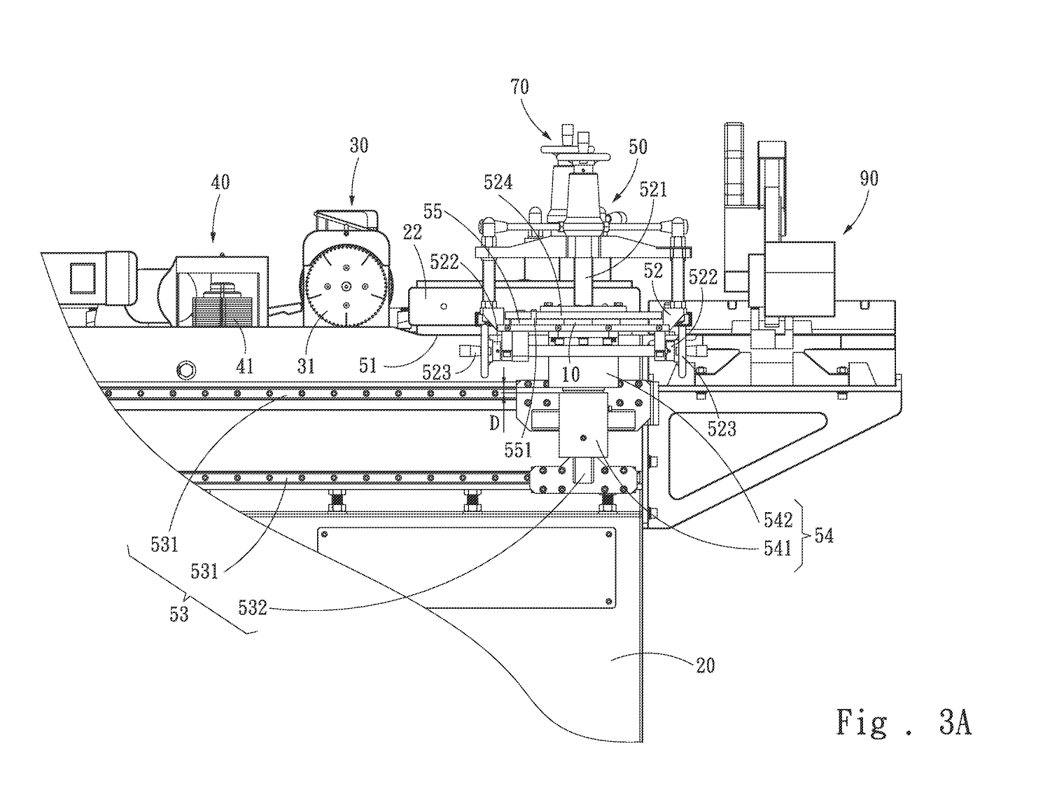

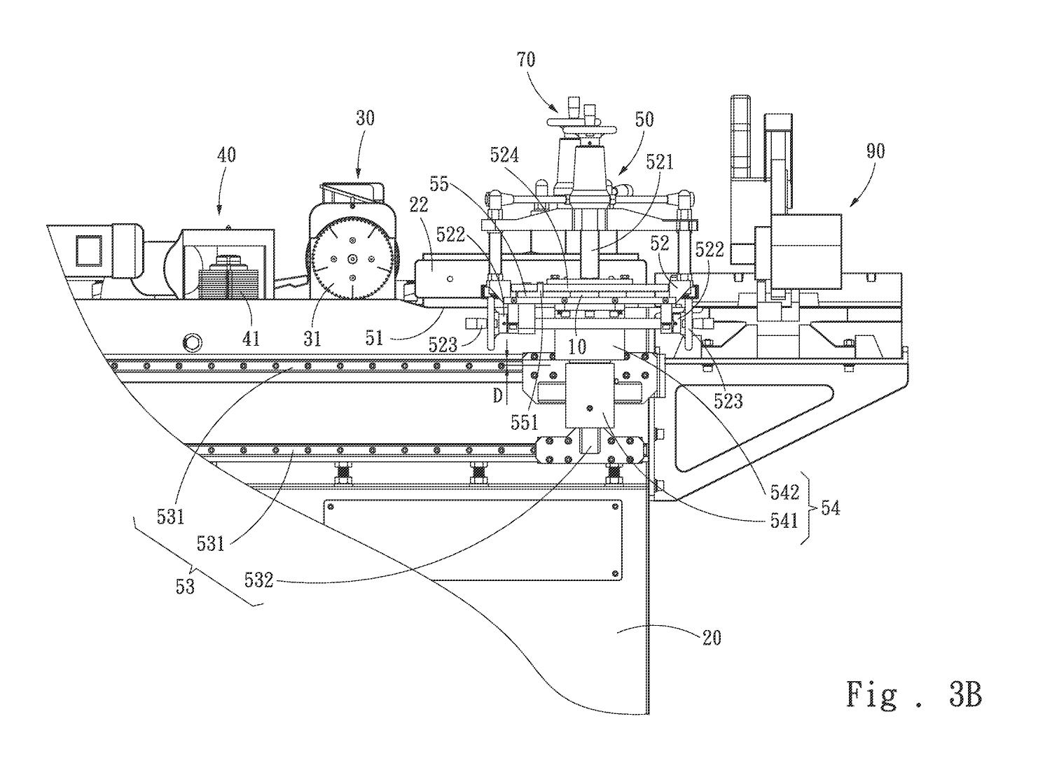

Please referring to FIGS. 2 and 3A, the present invention aims to provide a wooden tenon press and connection machine for coupling a plurality of wooden strips 10. It comprises a station 20, a plane cutting device 30, a sawtooth cutting device 40, a slide deck 50, a gluing device 60, a press device 70 and a thrust device 80. The station 20 has a working plane 21. The plane cutting device 30 is mounted onto the working plane 21 and has a plane cutter 31. The sawtooth cutting device 40 is mounted onto the working plane 21 and has a sawtooth cutter 41.

The slide deck 50 is located on the station 20 and has a holding deck 51 to hold a plurality of the wooden strips 10, a leaning panel 52 located at one side of the holding deck 51, a clamp panel 55 movable close to the leaning panel 52 to clamp the wooden strips 10, a slide element 53 to carry and slide the holding deck 51, and a rotary element 54 to carry the holding deck 51 to rotate 180 degrees. The slide element 53 can have a directing member 531 anchored on the station 20 and a slide base 532 to carry the holding deck 51 and the rotary element 54.

The clamp panel 55 can include two clamp portions 551 screwed through respectively by a clamp screw bar 522. The two clamp screw bars 522 are connected respectively to a rotary wheel 523. Through rotation of the rotary wheels 523 the two clamp portions 551 are driven to move close to the stationary leaning panel 52 to clamp the wooden strips 10.

The holding deck 51 can have a press member 521 located above the wooden strips 10. The press member 521 is anchored on the holding deck 51 and includes a press plate 524 to press and hold the wooden strips 10 still.

The working plane 21 can have a positioning plate 22 to be pressed by the wooden strips 10 to trim the end surfaces at two sides of the wooden strips 10 to pass through respectively where the plane cutter 31 and the sawtooth cutter 41 are located, and after the positioning is finished the wooden strips 10 are clamped tightly by the clamp panel 55 for positioning. Through sliding of the slide element 53 and rotation of the rotary element 54 the two side end surfaces of the wooden strips 10 can pass through the plane cuter 31 and the sawtooth cutter 41 to form a wooden tenon 12 on each of the end surfaces at two sides of the wooden strips 10. It is to be noted that, after rotation of the rotary element 54 the positions of the end surfaces at two sides of the wooden strips 10 to pass through the plane cutter 31 and the sawtooth cutter 41 have to be trimmed anew via the positioning plate 22. In the event of no rotary element 54 the wooden strips 10 can be rotated manually, thus also can form the wooden tenons 12 on the end surfaces at two sides of the wooden strips 10.

Please also referring to FIG. 3B, the rotary element 54 has a holding bar 541 anchored on the station 20 and a rotary bar 542 to support the holding deck 51. The rotary bar 542 screws into the holding bar 541. The holding bar 541 and the rotary bar 542 are spaced from each other at a relative distance D which is changeable with rotation of the rotary bar 542, hence while the holding deck 51 is rotated for 180 degrees its elevation also is changed at the same time to allow the wooden tenons 12 on the two end surfaces of the wooden strips 10 staggered up and down at a selected distance so that a desired coupling can be formed. The holding deck 51, aside from changing the elevation through rotation also can achieve the same purpose through an elevation adjustment element (not shown in the drawings). Operation of the elevation adjustment element can be accomplished manually, electrically, pneumatically or the like, details are omitted herein.

The gluing device 60 is mounted onto the working plane 21 and has a glue box 61 to receive the wooden tenons 12 of the wooden strips 10. The glue box 61 contains a glue 62 to daub on the wooden tenons 12. The glue box 61 also can include a serrated glue dispensing wheel 63 inside corresponding to the wooden tenons 12 so that even small crevices of the wooden tenons 12 can be daubed with the glue.

The press device 70 is mounted onto the working plane 21 and includes a press plate 71 movable up and down to press the wooden strips 10 at a definite pressure to generate a static friction force between the wooden strips 10 and the working plane 21. The press device 70 can include a pylon 72 which has a revolving wheel 73 and a pylon screw bar 74. The pylon screw bar 74 screws through the pylon 72 and has a distal end fastened to the press plate 71. By rotating the revolving wheel 73 the elevation of the press plate 71 can be changed to hold the wooden strips 10 to avoid the wooden strips 10 from rotating or skewing in the downstream fabrication processes.

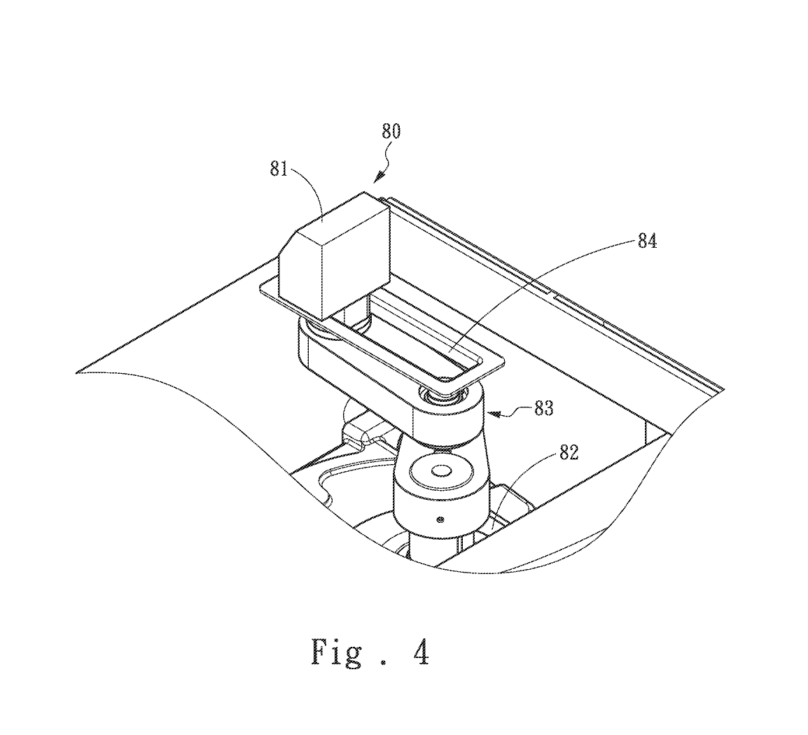

Please also referring to FIG. 4, the thrust device 80 is mounted onto the working plane 21 and includes a thrust portion 81 which has a movement path toward the press plate 71. The thrust device 80 also has a driving power source 82, a link movement mechanism element 83, and a slide slot 84 to hold the thrust portion 81. The link movement mechanism element 83 has two ends connected respectively to the driving power source 82 and the thrust portion 81. The driving power source 82 drives the link movement mechanism element 83 and also moves the thrust portion 81 upward on the slide slot 84. When the thrust portion 81 pushes two wooden tenons 12 in a fully coupled condition the thrust force of the thrust portion 81 is greater than the static friction force, hence the wooden strips 10 slide on the working plane 21. As a result, at the instant when the two wooden tenons 12 are fully coupled, they can absorb excessive impact force to avoid the wooden strips 10 from fracturing, meanwhile, also avoid the wooden strips 10 from warping at the junction of the wooden tenons 12 caused by too much forces received by the wooden strips 10. The driving power source 82 can be an electric motor, hydraulic force, animal force, human force or the like, as long as it can drive the thrust portion 81 moving.

In addition, the plane cutting device 30 and the sawtooth cutting device 40 can be positioned on the same side of the working plane 21, while the thrust device 80 and the press device 70 on another side of the working plane 21 so that the plane cutting device 30, the sawtooth cutting device 40, the thrust device 80 and the press device 70 surround the working plane 21, namely, the equipment required to press and couple the wooden tenons 12 are surrounding the working plane 21 and located on the same station 20.

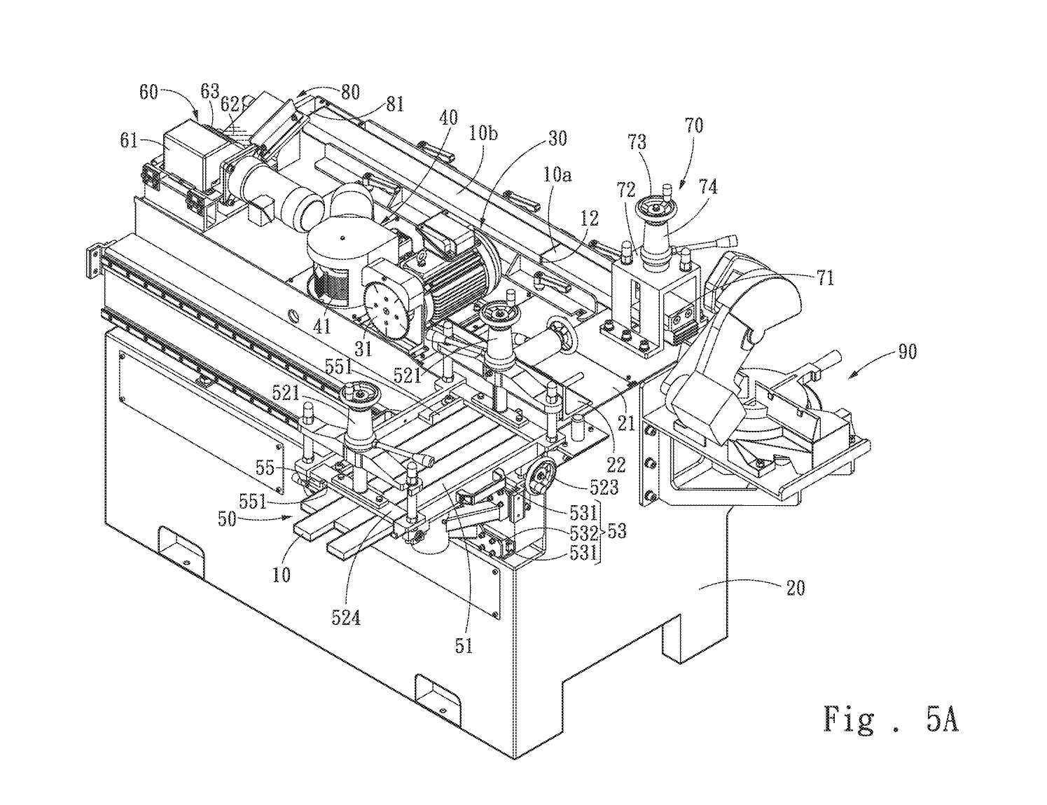

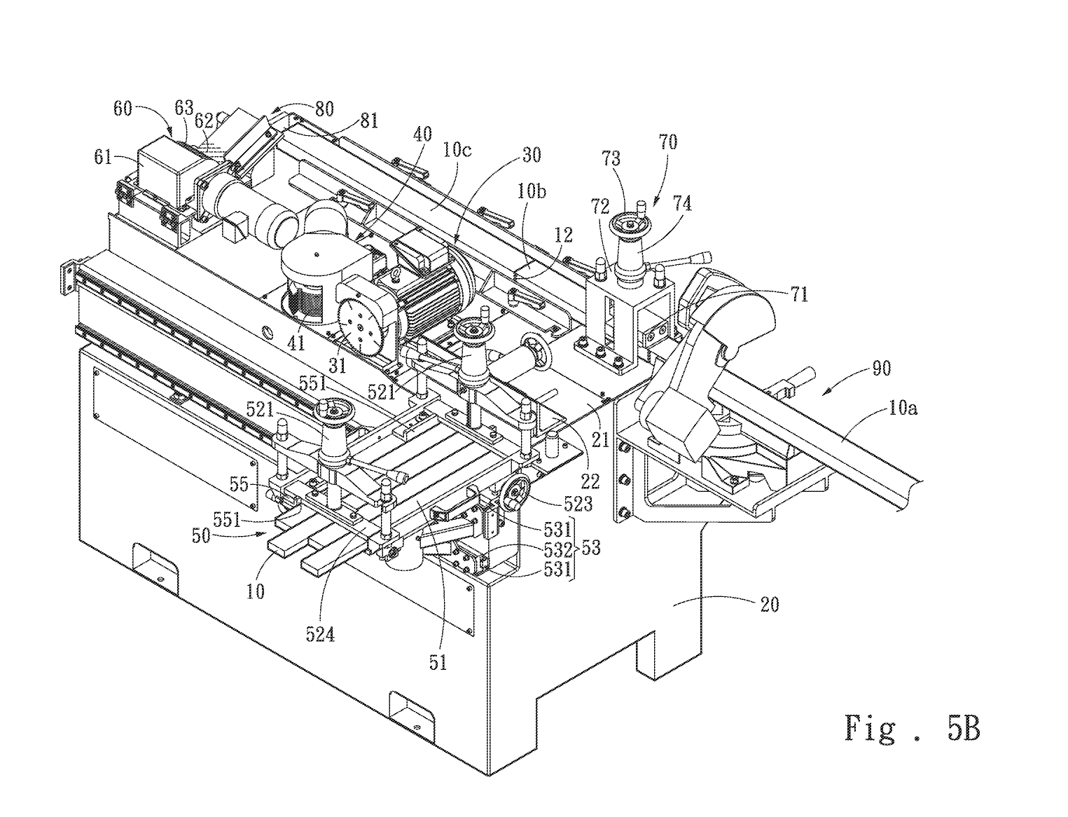

Also referring to FIGS. 5A and 5B, during actual coupling process of the wooden strips 10 any one of the wooden strips 10 (such as a first wooden strip 10a) can be held stationary by the press plate 71, and the wooden tenon 12 faces the thrust portion 81, while the thrust portion 81 pushes another wooden strip 10 (such as a second wooden strip 10b) to move the two wooden tenons 12 close to each other and couple together (as shown in FIG. 5A). When the two wooden tenons 12 have been coupled together, but the thrust portion 81 continues pushing, the wooden strips 10a held by the press plate 71 slides away to avoid the wooden strip 10 from the risk of fracturing; when a next wooden strip 10 (such as a third wooden strip 10c) is to be coupled, if the retreated thrust portion 81 has enough space to accommodate the wooden strip 10c, it can be directly placed; if the space is not sufficient, the press plate 71 can be loosened and moved outward (with a movable support station to support the first wooden strip 10a), then hold the wooden strip 10 (the second wooden strip 10b) stationary via the press plate 71, then a sufficient space can be generated to hold the wooden strip 10c, and the thrust portion 81 can push the wooden strip 10 (the third wooden strip 10c) to move the two wooden tenons 12 close to each other and couple together (as shown in FIG. 5B). After the coupling is finished, it can be cut via a cutting machine 90 to get a length desired to meet use requirement.

As a conclusion, the invention can provide many advantages, notably:

1. By pressing the wooden strips to form coupling, the length of the spliced wooden strips can be increased flexibly without being constrained by the length of the working plane.

2. When the thrust force of the thrust portion is greater than the static friction force the wooden strips can slide on the working plane to absorb excessive impact force to avoid the wooden strips 10 from fracturing, and also avoid the wooden strips from warping at the junction of the wooden tenons cause by excessive force received by the wooden strips, hence upper press plate is no longer needed, and fabrication cost can be reduced.

3. The equipment required for pressing and coupling the wooden tenons can be arranged to surround the working plane on the same station, hence also can save plant space.

4. With the rotary bar screwed into the holding bar, when the holding deck is swiveled for 180 degrees, its elevation also is changed so that two end surfaces of the wooden strips can be staggered up and down at a desired distance to form desired coupling.

5. The various elements of the invention can be driven via a single driving source, hence by merely providing a single and stable driving source operation on the station can be accomplished, therefore can meet use requirements and also improve usability.

What is claimed is:

1. A wooden tenon press and connection machine for coupling a plurality of wooden strips, comprising:
a station including a working plane;
a plane cutting device mounted onto the working plane and including a plane cutter;
a sawtooth cutting device mounted onto the working plane and including a sawtooth cutter;
a slide deck mounted onto the station and including a holding deck to hold the wooden strips, a leaning panel at one side of the holding deck, a clamp panel movable close to the leaning panel to clamp the wooden strips, and a slide element to carry and slide the holding deck; wherein through slide of the slide element end surfaces of the wooden strips are passed through the plane cutter and the sawtooth cutter to form a tenon on each of the end surfaces of the wooden strips;
a gluing device mounted onto the working plane and including a glue box to receive the wooden tenon of the wooden strips, the glue box including a glue to daub on the wooden tenon;
a press device mounted onto the working plane and including a press plate movable up and down to press the wooden strips at a definite pressure; and
a thrust device mounted onto the working plane and including a thrust portion which has a movement path toward the press plate, and one of the wooden strips being held stationary by the press plate.

2. The wooden tenon press and connection machine of claim 1, wherein the slide deck further includes a rotary element to carry and swivel the holding deck so that the end surfaces of two sides of the wooden strips pass through the plane cutter and the sawtooth cutter respectively to form the wooden tenon on each of the end surfaces of the two sides of the wooden strips.

3. The wooden tenon press and connection machine of claim 2, wherein the rotary element includes a holding bar anchored on the station and a rotary bar to support the holding deck, the rotary bar screwing into the holding bar to change the elevation of the holding deck while the holding deck is swiveling.

4. The wooden tenon press and connection machine of claim 1, wherein the holding deck includes a press member anchored thereon, and the press member includes a press plate to press the wooden strips stationary.

5. The wooden tenon press and connection machine of claim 1, wherein the clamp panel include two clamp portions which are screwed through respectively by a clamp screw bar, the two clamp screw bars being connected to a rotary wheel.

6. The wooden tenon press and connection machine of claim 1, wherein the press device includes a pylon which includes a revolving wheel and a pylon screw bar, the pylon screw bar screwing through the pylon and including a distal end fastened to the press plate.

7. The wooden tenon press and connection machine of claim 1, wherein the thrust device includes a driving power source, a link movement mechanism element and a slide slot to hold the thrust portion, the link movement mechanism element having two ends connected respectively to the driving power source and the thrust portion, the driving power source driving the link movement mechanism element to move the thrust portion on the slide slot.

8. The wooden tenon press and connection machine of claim 1, wherein the working plane includes a positioning plate pressed by the wooden strips, the trimmed end surfaces of the wooden strips passing through where the plane cutter and the sawtooth cutter are located.

9. The wooden tenon press and connection machine of claim 1, wherein the plane cutting device and the sawtooth cutting device are located at a same side of the working plane, and the thrust device and the press device are located at a same other side of the working plane so that the plane cutting device, the sawtooth cutting device, the thrust device and the press device surround the working plane.
